(19) United States
(12) Patent Application Publication
(10) Pub. No.: US 2004/0141533 A1
(43) Pub. Date: Jul. 22, 2004

(54) Wavelength tunable laser source

(76) Inventors: Herve Lefevre, Paris (FR); Philippe Graindorge, Paris (FR); Gerald Roosen, La Celle (FR); Jean-Michel Jonathan, Sevres (FR); Gilles Pauliat, Les Ulis (FR)

Correspondence Address: ARENT FOX KINTNER PLOTKIN & KAHN, 1050 CONNECTICUT AVENUE, N.W., SUITE 400, WASHINGTON, DC, 20036, US

(21) Appl. No.: 10/398,288

(22) PCT Filed: Oct. 10, 2001
(86) PCT No.: PCT/FR01/03129

(30) Foreign Application Priority Data
Oct. 10, 2000 (FR) 00/12958

(51) Int. Cl. H01S 3/10; H01S 3/082

(52) U.S. Cl. 372/20; 372/97

(57) ABSTRACT

This invention relates to a continuously wavelength tunable monomode laser source with external cavity comprising a resonant cavity having a reflecting plane face, means for extracting a portion of the luminous flux and a retroreflecting dispersive device, an amplifier wave guide located inside the resonant cavity, means for controlling the retroreflecting dispersive device providing continuous tunability.

The laser source comprises a photo-refractive component located in the cavity, sensitive to the wavelength of the laser source, within which is formed a Bragg grating.

This invention relates to a wavelength tunable monomode laser source with external cavity.

It is known that a resonant optical cavity of a laser source selects one or several wavelengths emitted by a laser amplifier medium. There are most often two mirrors whereas one of them is partially transparent, forming a so-called Fabry-Perot cavity. Such a Fabry-Perot cavity selects, or provides resonance for semi-wavelengths equal to sub-multiples of the optical length Lₒₚ of the cavity and therefore generally quite close to one another. Several wavelengths may then be amplified by the wide spectrum amplifier medium. A multimode laser is thereby produced.

For certain applications, monomode lasers are preferred. It is then necessary to implement a resonant optical cavity connected to a selection means in addition to the Fabry-Perot cavity, for instance to replace one of its mirrors with a retroreflecting dispersive device.

Retroreflecting dispersive devices are widely used in conventional optics. The most well-known device is probably the plane grating of pitch p used according to the Littrow configuration.

Generally, a plane grating of pitch p has a dispersion plane perpendicular to its lines. A collimated luminous beam of wavelength λ, tilted by an angle θ₁ relative to the normal of the grating which is parallel to the dispersion plane of the grating, produced a collimated beam also parallel to the dispersion plane and having a direction tilted by an angle θ₂ relative to the normal, θ₁ and θ₂ being linked by the relation:

p sin θ₁+p sin θ₂=λ

In tunable laser sources with external cavity operating with a so-called Littman-Metcalf configuration where the incident collimated beam forms an angle θ₁ with the normal to the grating, an additional mirror is placed with its normal having an angle θ₂ on the grating. The wavelength λ which follows λ=p sin θ₁+p sin θ₂ is dispersed by the grating at an angle θ₂, then is retroreflected on the mirror which is then perpendicular thereto, and finally is back-dispersed again in the grating in return and emerges at the input angle θ₁. This wavelength λ is therefore selected in the cavity. The wavelength tunability is obtained by varying the orientation of the grating-mirror assembly, i.e. by varying θ₁, or by varying the orientation of the mirror only, i.e. by varying θ₂ or finally by varying the orientation of the grating only, i.e. by varying θ₁ and θ₂ while keeping θ₁-θ₂ constant.

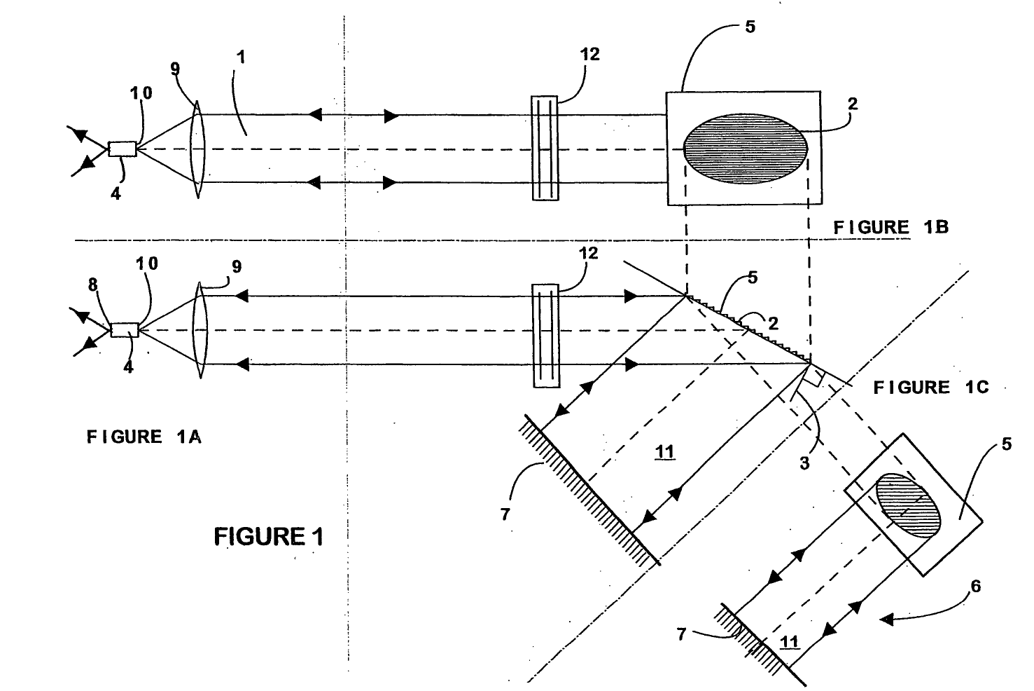

FIG. 1 represents a grating 5 implemented according to the Littman-Metcalf assembly wherein one end 10 of a guided monomode amplifier medium 8 is located at the focus of collimation optics 9 which produce a main collimated beam 1 of wavelength λ.

This beam is parallel to the dispersion plane of the grating, i.e. to the plane perpendicular to the lines 2 of the grating 5, and forms an angle θ₁ with the normal 3 at the surface of the grating 5. By diffraction on the grating, the beam 1 produces a secondary collimated beam 11 which lies in the dispersion plane and forms an angle θ₂ with the normal 3. A plane mirror 7 is located perpendicular to the beam 11 and the beam is retroreflected throughout the system.

It is known under such conditions that p being the pitch of the grating, when the relation p sin θ₁+p sin θ₂=λ is verified, the beam 1 loops back after a first diffraction on the grating 5, retroreflection on the mirror 7 and a second diffraction on the grating 5. It therefore produces a picture point merged with the end 10.

Tunable laser sources can then be made, the tunability being obtained by the adjustment of retroreflecting dispersive system.

However, such devices may generate mode jumps. Indeed, the rotation of the grating dispersive device changes the selected wavelength, but this wavelength must also satisfy the resonance condition of any optical cavity which indicates that the optical length Lₒₚ of the cavity (in single use) is equal to an integer N of semi-wavelength:

Lₒₚ=N.λ/2

If the selected wavelength decreases, the cavity should be shortened simultaneously, and conversely, it should be lengthened when the wavelength increases, to remain on the same integer N and avoid any mode jumps.

A continuous tunability device without any mode jump has been suggested with a Littrow configuration (distinct of the Littman-Metcalf configuration (F. Favre and D. the Guen, “82 nm of continuous tunability for an external cavity semi-conductor laser”, Electronics Letters, Vol. 27, 183-184, [1991]), but it requires a complex mechanical assembly using two translation movements and two rotational movements.

In an article of 1981, Liu and Littman (Optics Letters, vol. 6, N° 3, March 1981, pp. 117-118) describe a device comprising a grating and a mirror with variable orientation implemented for the making of a variable wavelength monomode laser. The geometry suggested provides continuous wavelength scanning.

Besides, dihedron reflectors have been studied for a long time. In particular, the Japanese patent application JP-A-57.099793 dated 21 Jun. 1981 suggests to use such a dihedron to obtain a retroreflecting dispersive device in a wavelength multiplexed optical fibre communication system, whereas such wavelengths are fixed.

Such a continuously tunable monomode laser source has also been described in the European patent application 0.702.438 which uses a Littman-Metcalf configuration.

The French patent application 2.775.390 also relates to a continuously wavelength tunable monomode laser source comprising means for providing a servosystem of the position of the retroreflecting dispersive device relative to the emission wavelength, in order to limit the mode jumps as the wavelength varies.

The different devices of the prior art produce satisfactory results, whereas the variation of the wavelength causes but few mode jumps. However, the aim of this invention is to improve the performances of these sources still further.

Moreover, the advantages provided by the implementation of a photo-refractive crystal in a laser cavity are also well-known (J. M. Ramsey and W. B. Whitten—Optics Letters—November 1987, Vol. 12, N° 11).

Such a crystal located inside a laser cavity is subject to the waves propagating inside the cavity which, by interference, produce inside the crystal fringes relative to the wavelength, whereas said fringes induce index variations constituting a Bragg grating.

It has been shown for instance in the article mentioned above that the presence of such a component enables to fine-tune the spectrum of the luminous flux produced by the laser.

Such a component has therefore been considered until now as likely to replace the grating of the retroreflecting dispersive system described above, with the additional advantage of self-adaptation to the emission frequency of the laser.

The invention relates therefore to a wavelength tunable monomode laser source, with external cavity, comprising a resonant cavity having a reflecting plane face, means for extracting a portion of the luminous flux and a retroreflecting dispersive device, at least one amplifier wave guide located inside the resonant cavity, means for controlling the retroreflecting dispersive device which provides continuous tunability.

The plane face of the cavity may be totally or partially reflecting. In the latter case, it also provides the means for extracting a portion of the luminous flux.

According to the invention, this laser source monomode comprises a photo-refractive component located in the cavity, sensitive to the wavelength of the laser source, within which is formed a Bragg grating.

It will appear from the detailed description that such an arrangement enables not only fine-tuning of the spectral distribution of the luminous flux produced by the source but also that it limits the risks of mode jump, as the wavelength varies. This provides either increased stability of the source, or increased flexibility in the meeting the conditions of manufacture required usually.

In various embodiments each exhibiting specific advantages and liable to be combined in different possible configurations, this monomode laser source shows the following features:

the photo-refractive component is a gallium arsenide crystal (GaAs),

the photo-refractive component is a cadmium tellurium crystal (CdTe),

the photo-refractive component is located approximately at an equal optical distance from each of the reflectors of the resonant cavity of the laser,

the retroreflecting dispersive device is in the Littman-Metcalf configuration,

the mirror of the retroreflecting device is a dihedron providing self-alignment of the beam in the direction perpendicular to the spreading of the spectrum,

the retroreflecting device comprises an assembly comprising of a lens and a ridge reflector dihedron perpendicular to the dispersion plane of the grating forming a single-dimension self-aligned reflector assembly,

the retroreflecting dispersive device is in the Littrow configuration,

the source is continuously tunable,

the monomode laser source comprises several amplifier wave guides, a single photo-refractive component and means for selecting the amplifier wave guide which determines the emission wavelength of the source,

the amplifier wave guide is a diode laser whereof one of the ends provides the output face of the laser,

the laser source produces a beam whereof the wavelength varies in the vicinity of 1 550 nm,

the laser source comprises a servosystem of the retroreflecting dispersive device relative to the emission wavelength of the laser.

The invention will be described thereunder in detail with reference to the appended drawings wherein:

FIG. 1 is a schematic representation of the laser source of the invention:

FIG. 1A being a top view,

FIG. 1B being a side view of one of the arms of the source,

FIG. 1C being a side view of the other arm of this source;

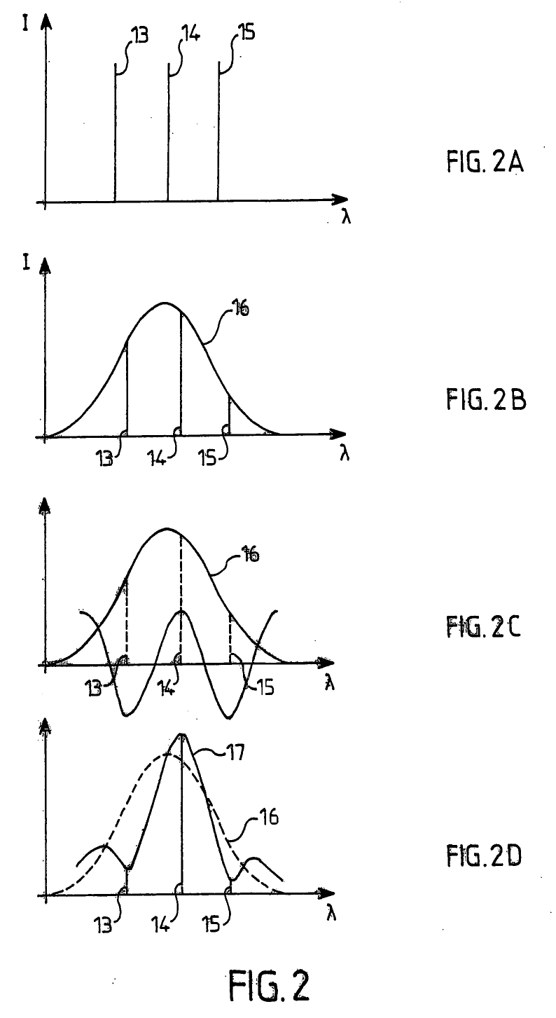

FIG. 2 is a representation of the modes of the luminous flux produced by the source:

FIG. 2A is a representation of the modes of the Fabry-Perot cavity of the laser,

FIG. 2B is a representation of the modes produced by the source, according to the prior art, in the absence of a photo-refractive component,

FIG. 2C is a separate representation of the separate effects of the dispersive system and of the photo-refractive component;

FIG. 2D is a representation of the modes selected according to the invention;

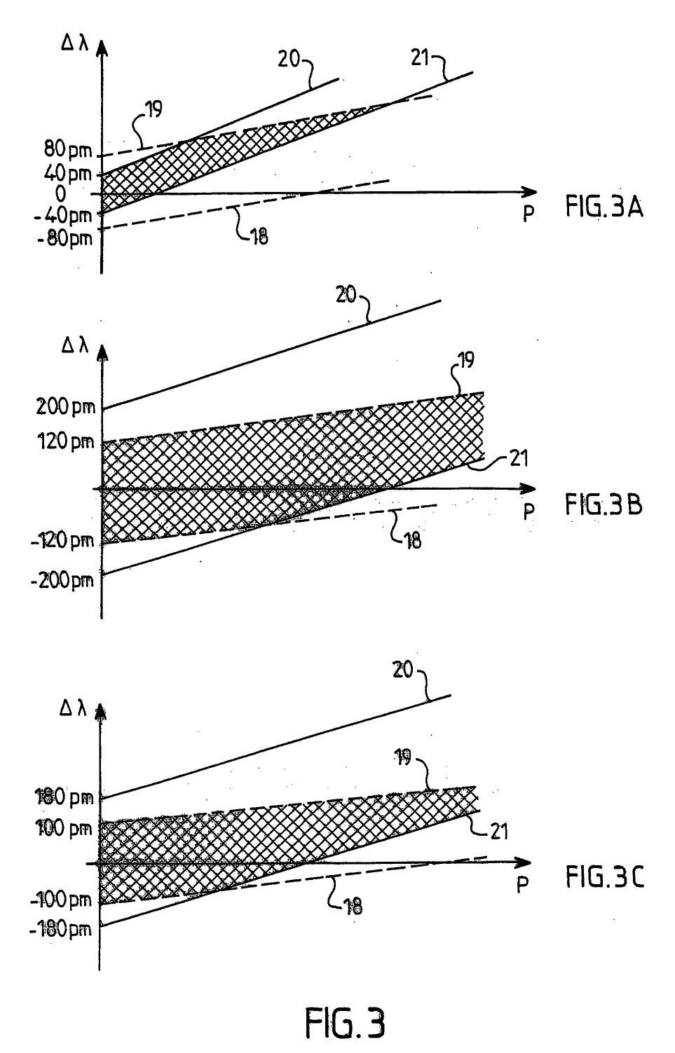

FIG. 3 is a comparative representation of the performances of the source,

FIG. 3A represents the operating range of a conventional tunable laser source,

FIG. 3B represents the operating range of a tunable source according to the invention provided with a photo-refractive component made of cadmium tellurium,

FIG. 3C represents the operating range of a tunable source according to the invention provided with a photo-refractive component made of gallium arsenide.

The conventional components of a tunable source have been described above relative to the prior art and are represented on FIG. 1 with the same reference numbers.

According to the invention, a photo-refractive component 12 is located in the cavity.

Such a photo-refractive component is sometimes referred to as dynamic, it is subject to stationary luminous waves present in the cavity of the laser which inscribe therein a Bragg grating whereof the features are linked to the wavelength thereof. When said wavelength varies, the Bragg grating changes, the period of these fringes being modified.

The presence of such a photo-refractive component 12 generates physical phenomena which may be interpreted while considering that said component acts as a filter on the luminous flux(es) provided in the cavity. In fact, several modes being always provided in the cavity, a central mode and adjacent modes, this photo-refractive component 12 weakens the adjacent modes and promotes simultaneously the central mode.

This enables thus to obtain the selection of modes already described in the prior art as well as a source with greater spectral purity. In addition to this effect, it has been noticed that in a tunable source, this photo-refractive component 12 changes simultaneously with the variation of the wavelength, even in a relatively wide spectral range, and that thus, not only it contributes to improving the spectral purity of the source but, moreover, it avoids certain residual mode jumps which might have occurred during the wavelength scanning of the source in spite of the various devices implemented to avoid such jumps.

The additional implementation of a dispersive device 5 within the cavity of a tunable laser had not been contemplated, in order to fine-tune the spectrum and, under certain conditions, to avoid mode jumps, and a second dispersive device such as the photo-refractive component 12 having complementary properties.

However, experience has shown the possibility of obtaining cumulative selection effects, on the one hand, by the grating of retroreflecting dispersive system 5, 7 and, on the other hand, by the photo-refractive component 12.

These effects can be obtained with a single photo-refractive component 12 whereas the emission wavelength is variable.

To do so, the laser can implement a Littman-Metcalf cavity or a Littrow cavity which also provides continuous tunability. It can also be made with several amplifier wave guides actuated each in turn relative to the emission wavelength requested. In such a case still, it has been noticed that it was possible to use a single photo-refractive component.

It has been noticed that this accumulation of effects was optimised when the photo-refractive component 12 was located at an equal optical distance from each of the reflectors, respectively 8 and 7, of the resonant cavity of the laser.

A possible representation of this situation is given on FIG. 2 where the axis of abscissas is the wavelength and the axis of ordinates is the luminous intensity, where the modes 13, 14, 15 of the Fabry-Perot cavity of the laser represented on FIG. 2A are affected by the implementation of the single grating 5 which has a Gaussian response curve 16 as represented on FIG. 2B.

The implementation of the photo-refractive component 12, when it is placed halfway from the reflectors 8, 7 of the Fabry-Perot cavity, has a sine wave effect 17 whereof the period is twice the spacing of the modes of the Fabry-Perot cavity, which hence contributes by amplification of the wavelength of the dominant mode in improving the amplification thereof with detriment to the adjacent modes which are weakened at the maximum when the photo-refractive component is located in this position. This effect of the photo-refractive component 12 is represented individually relative to the response curve of the grating on FIG. 2C and cumulatively therewith on FIG. 2D.

The power of the main mode is thus increased relatively to the adjacent modes.

The invention is advantageously implemented for the realisation of a source usable for the tests of telecommunication networks by optical fibres, for instance in the near-infrared region at wavelengths varying in the vicinity of 1 550 nm.

Good results have been obtained by making the photo-refractive component, either with a gallium arsenide crystal, or with a cadmium tellurium crystal. These crystals are particularly efficient in the wavelength range mentioned above.

The invention can be implemented with different types of tunable sources other than the retroreflecting dispersive device either in the Littrow configuration or in the Littman-Metcalf configuration.

The different improvements enhancing the stabilisation of the tunable source and to avoid mode jumps may advantageously be combined with this invention, in particular, the operation of such a source has been improved by using a dihedron as a mirror of the retroreflecting device. This dihedron ensures self-alignment of the beam in the direction perpendicular to the spreading of the spectrum.

In another embodiment, the retroreflecting device comprises an assembly comprising a lens and a ridge reflector dihedron perpendicular to the dispersion plane of the grating. This assembly forms a single-dimension self-aligned reflector.

With a view to good stabilisation of the luminous beam, we have seen that the positioning of the photo-refractive crystal, approximately halfway from the cavity, was decisive. This position enables indeed to protect against any possible mode jump generated by the Fabry-Perot cavity formed by the antiglare of the amplifier medium and the grating. The coupling between this smaller cavity and the greater cavity is a source of instability.

There now exists another possible source of mode jump for the luminous beam.

The elongation of the cavity implies indeed greater coupling between the modes and smaller selectivity of the grating. One must therefore determine in which conditions the operation is obtained without any mode jump.

FIGS. 3A, 3B and 3C show the possible operating ranges, without any mode jump, for a cavity without any photo-refractive crystal (3A) or, according to the invention, with a gallium arsenide crystal (3C), respectively with a cadmium tellurium crystal (3B).

On these figures the axis of abscissas represents the output power of the source, the axis of ordinates the wavelength offset of the main mode relative to the maximum transmission of the grating.

The curves 18 and 19 represent the limits of occurrence of a double mode jump, and the curves 20 and 21, the limits of occurrence of a mode jump, the source is therefore stable as long the operating point lies inside the zone 22 delineated by these curves.

Significant increase in the surface of this stable operating zone 22 is hence shown when using a photo-refractive crystal according to the invention (FIGS. 3B and 3C).

FIGS. 3B and 3C show that the introduction in the cavity of a photo-refractive crystal such as a cadmium tellurium crystal enables to limit significant mode jumps relative to the cavity without any component. The operating range is widened considerably.

The value of the parameters taken into account to obtain FIGS. 3A, 3B and 3C is as follows: length of the cavity formed by the antiglare and the grating of the order of 30 mm, thickness of the cadmium tellurium crystal or of gallium arsenide crystal of the order of 4 mm.

1. A wavelength tunable monomode laser source with external cavity comprising:
a resonant cavity having a reflecting plane face, means for extracting a portion of the luminous flux and a retroreflecting dispersive device,
at least one amplifier wave guide located inside the resonant cavity,
means for controlling the retroreflecting dispersive device providing continuous tunability,
characterised in that it comprises a photo-refractive component located in the cavity, sensitive to the wavelength of the laser source, within which is formed a Bragg grating.

2. A wavelength tunable monomode laser source according to claim 1, characterised in that the photo-refractive component is a gallium arsenide crystal (GaAs).

3. A wavelength tunable monomode laser source according to claim 2, characterised in that the photo-refractive component is a cadmium tellurium crystal (CdTe).

4. A wavelength tunable monomode laser source according to anyone of claims 1 to 3, characterised in that the photo-refractive component is located approximately at an equal optical distance from each of the reflectors of the resonant cavity of the laser.

5. A wavelength tunable monomode laser source according to anyone of claims 1 to 4, characterised in that the retroreflecting dispersive device is in the Littman-Metcalf configuration.

6. A wavelength tunable monomode laser source according to claim 5, characterised in that the mirror of the retroreflecting device is a dihedron providing self-alignment of the beam in the direction perpendicular to the spreading of the spectrum.

7. A wavelength tunable monomode laser source according to claim 6, characterised in that the retroreflecting device comprises an assembly comprising of a lens and a ridge reflector dihedron perpendicular to the dispersion plane of the grating forming a single-dimension self-aligned reflector assembly.

8. A wavelength tunable monomode laser source according to anyone of claims 1 to 4, characterised in that the retroreflecting dispersive device is in the Littrow configuration.

9. A wavelength tunable monomode laser source according to anyone of claims 1 to 8, characterised in that the source is continuously tunable.

10. A wavelength tunable monomode laser source according to anyone of claims 1 to 4, characterised in that it comprises several amplifier wave guides, a single photo-refractive component and means for selecting the amplifier wave guide which determines the emission wavelength of the source.

11. A wavelength tunable monomode laser source according to anyone of claims 1 to 10, characterised in that the amplifier wave guide is a laser diode whereof one of the ends provides the output face of the laser.

12. A wavelength tunable monomode laser source according to anyone of claims 1 to 11, characterised in that it produces a beam whereof the wavelength varies in the vicinity of 1550 nm.

13. A wavelength tunable monomode laser source according to anyone of claims 1 to 12, characterised in that the retroreflecting dispersive device is a servosystem relative to the emission wavelength of the laser.
